(19) United States
(12) Patent Application Publication
(10) Pub. No.: US 2022/0054982 A1
(43) Pub. Date: Feb. 24, 2022

(54) Apparatus with multi-stage cross flow membrane filtration

(71) Applicant: SD FILTRATION A/S, Shanderborg (DK)

(72) Inventors: Ulrik Johansen, Skanderborg (DK); Michael S. Bundgaard, Skanderborg (DK); Keld B. Andreasen, Skanderborg (DK)

(21) Appl. No.: 17/297,121

(22) PCT Filed: Dec. 10, 2019
(86) PCT No.: PCT/EP2019/084371

§ 371 Date: May 26, 2021

(30) Foreign Application Priority Data
Dec. 11, 2018 (DK) PA 2018 00984
May 29, 2019 (DK) PA 2019 00668

(51) Int. Cl. B01D 61/22; B01D 61/18; B01D 63/10; B01D 65/02; B01D 61/14; A23C 9/142; A23L 2/74

(52) U.S. Cl. CPC B01D 61/22; A23V 2002/00; B01D 63/106; B01D 65/02; B01D 61/142; A23C 9/1422; A23C 9/1425; A23L 2/74; B01D 2311/14; B01D 2315/10; B01D 2315/16; B01D 2317/022; B01D 2317/04; B01D 2313/243; B01D 61/18

(57) ABSTRACT

An outlet (3) for fluid feed of a first membrane module (1a) is connected to a fluid inlet (2) of a second membrane module (1b), and if further membrane module(s) is/are present, the outlet (3) for fluid feed of a previous membrane module (n−1) is connected to the fluid inlet (2) of a following membrane module (n), and for the last membrane module (n), the outlet (3) for fluid feed is connected to the fluid inlet (2) for fluid feed of the first membrane module (1a). An amount of fluid feed is continuously pumped with pressure PB through a loop of n membrane modules that are serially connected, the fluid feed and permeate flow concurrently through each of the n membrane module(s), generated permeate is continuously drained from each membrane module through a permeate outlet, permeate pressure at the permeate outlet of each membrane module is controlled within a range.

### BACKGROUND ART

A membrane is a thin layer of semi-permeable material that separates substances when TMP is applied to the membrane. Membrane processes are increasingly used for removal of bacteria, microorganisms, particulates, and natural organic material, which can impart color, tastes, and odors to water and react with disinfectants to form disinfection byproducts. As advancements are made in membrane production and module design, capital and operating costs continue to decline. Often used membrane processes are microfiltration (MF), ultrafiltration (UF), nanofiltration (NF), and reverse osmosis (RO).

Microfiltration (MF) is loosely defined as a membrane separation process using membranes with a pore size of approximately 0.03 to 10 microns (1 micron=0.0001 millimeter), and a relatively low feed operating pressure of approximately 50 to 400 kPa (7 to 60 psi). Materials commonly removed by MF include sand, silt, clays, Giardia lamblia and Crypotosporidium cysts, algae, and some bacterial species. MF is also used as a pretreatment to RO or NF to reduce fouling potential.

Ultrafiltration (UF) is loosely defined as a membrane separation process using membranes with a pore size of approximately 0.002 to 0.1 microns, a MWCO of approximately 1,000 to 100,000 daltons, and an operating pressure of approximately 120 to 700 kPa (17 to 100 psi). UF will remove all microbiological species removed by MF (partial removal of bacteria), as well as some viruses (but not an absolute barrier to viruses) and humic materials.

The document WO 2015/135545 discloses an apparatus and a method for membrane filtration. The apparatus has a membrane housing (2) comprising a feed inlet (3) and a feed outlet (4), further, the membrane housing (2) comprises at least two membrane elements (10, 20) each element having an associated permeate tube and outlet (11, 21). WO 2015/135545 teaches how to increase flux of material by placing more than one membrane element in serial position relative to fluid feed flow, but as the permeate flows countercurrent compared to the fluid feed flow, the permeate will face an increasing pressure and increasing incoming flux when flowing towards the feed inlet (3). This feature causes a risk of a dead pocket appearing in the permeate tube closest to the central ATD (15), either during production or during cleaning, which is highly undesirable if the apparatus is used for separating food components such as whey or the like. Also, it is necessary to use a non-standard component in form of the ATD (15) blocking transport of permeate between the membrane elements, contrary to standard operation where the ATD allows transport of permeate through a central opening of the ATD.

The document WO 2003/055580 discloses a process for ultrafiltration using a spiral wound membrane filter. The document points to that the membrane elements of the apparatus disclosed in WO 2003/055580 may be operated at pressures significantly higher than the pressures known before publication of this document, the membrane elements may be operated at a pressure difference of 2 bar or more between the entrance and the outlet of a membrane element having a length of approximately 1 meter (see page 6, lines 3-7). The high pressure is established by designing the filter in a way so that the passage between the spiral wound element and the housing is open for incoming fluid at the entrance of the membrane element and blocked or restricted at the outlet of the membrane element. FIG. 11 discloses an embodiment where 4 membrane elements are serially positioned inside a membrane housing, in this embodiment, the flow is also directed toward the inlet of the fluid feed thereby providing the risk of a dead pocket. The prior art documents do not teach how to overcome use of non-standard components and prevent possible dead-pockets in the permeate flow.

### SUMMARY OF INVENTION

Thus, the present invention relates to an apparatus and a method for cross-flow membrane filtration which may be used for filtration processes requiring a controllable low Transmembrane Pressure (TMP) and at the same time a controllable high cross-flow. This may be the case both for microfiltration and for ultrafiltration processes. Particularly, the apparatus is directed to use in preparation of food ingredients where fractionating is required.

Also, the present invention secures concurrent flow directions for both retentate and permeate in all membrane elements using only standard equipment in the modules.

Also, the prior art documents do not teach how to build membrane systems where membrane housing in the same fluid feed loop can be placed on top of each other e.g. in layers e.g. in a square or rectangular matrix while problems relating to increased static pressure are overcome.

### Definitions of Words

ATD—Anti Telescoping Device, prevents spiral wound membranes from extending in a longitudinal direction due to liquid flow through the membrane element.

TMP—Trans Membrane Pressure, pressure difference between feed and permeate.

The TMP is calculated according to the formula:

$$TMP = \frac{{p}_{i n} + {p}_{o u t}}{2} - {p}_{perm} ,$$

where pᵢₙ is the fluid feed/retentate pressure before or at the inlet of a membrane module and pₒᵤₜ is the fluid feed/retentate pressure after or at the outlet of a membrane module. pₚₑᵣₘ is the permeate pressure at the permeate outlet of the module.

Dead leg—or dead pocket is used to describe a piping or the like where flow has ceased creating pockets of stagnant fluid which pockets support microbial amplification in the fluid. This is highly undesirable in systems used to prepare foodstuff or food components or drinking water.

Cross flow—Linear flow along the membrane surface. Purpose is to minimize or control the dynamic layer on the membrane surface.

Pressure loss per membrane element or dP per membrane element or dP/element—is the driving force for the above described cross flow. dP/element is the difference in pressure between pₘ, pressure of the fluid feed/retentate pressure before or at the inlet of a membrane module, and pₒᵤₜ, pressure of the fluid feed/retentate pressure after or at the outlet of a membrane module. dP/element=pᵢₙ−pₒᵤₜ.

Membrane element or element—a membrane element is an element comprising or constituted of a membrane which membrane provides a barrier allowing permeate to pass through the membrane and preventing retentate from passing through. In the context of the present application a membrane element may be a spiral wound membrane, where permeate flows from a peripheral position to a central opening of the membrane element.

Membrane module or module—assembly of one membrane housing including or comprising one or more membrane elements and ATDs and similar membrane housing interior, an inlet for fluid feed/retentate, an outlet for retentate and an outlet for permeate through which permeate separated from the one or more membrane elements of the one membrane housing is removed. The outlet for retentate and the outlet for permeate is positioned at the same end of the housing, i.e. opposite the inlet for feed/retentate providing concurrent flow of retentate and permeate.

Membrane module segment or segment—assembly of two or more membrane modules in serial connection

Section—parallel assembly of one or more segments

Loop—assembly of one or more modules or modules which may constitute one or more sections through which fluid feed is forced by a circulation pump.

The present invention provides a possibility for building both small and large compact apparatus for cross flow membrane filtration comprising membrane modules for filtration processes requiring even very low TMP. The apparatus according to the present invention offers a high controllability for TMP of each membrane module, independence of static lift height and allows independently adjustable cross flow.

According to one aspect of the invention, the invention relates to an apparatus for cross-flow membrane filtration comprising a plurality of n membrane housings (2, . . . , n) and a pump (13), where the membrane module (1) positioned immediately downstream of the pump is named the first membrane module (1a),
each membrane module (1) comprises at least one membrane element (4), one inlet (2) for fluid feed and one outlet (3) for fluid feed, one outlet for permeate (6), and a back-pressure control means (9) such as a valve configured to control the pressure and/or the flow at the outlet for permeate (6),
each membrane element (4) has a central opening (5) configured to collect permeate and direct the permeate to the outlet for permeate (6), which outlet for permeate (6) is positioned at the same end of the membrane module (1) as the outlet (3) for fluid feed providing concurrent flows in fluid feed and permeate in full length of each membrane module (1), wherein the outlet (3) for fluid feed of the first membrane module (1a) is connected to the fluid inlet (2) of the second membrane module (1b), and if further membrane module(s) is/are present, the outlet (3) for fluid feed of a previous membrane module (n−1) is connected to the fluid inlet (2) of a following membrane module (n), and for the last membrane module (n), the outlet (3) for fluid feed is connected to the inlet (2) for fluid feed of the first membrane module (1a).

The apparatus is directed to working at a low TMP, which is normally the case for microfiltration. That an outlet is connected to an inlet means that at least part of the fluid leaving through the outlet, normally all of the fluid, will enter the inlet.

According to any embodiment of the invention, each membrane module (1) may comprise a maximum of four membrane elements, normally each membrane module comprises only one or two membrane elements (4).

According to any embodiment of the invention, the number of membrane modules n is: n≥2, or n≥4, or 2≤n≤40, or 2≤n≤36, or 4≤n≤32.

The number n of membrane modules refers to membrane modules belonging to one segment, a segment is a group of membrane modules being serially connected on the fluid feed side of the membrane module, i.e. a part of the fluid feed entering the first membrane module of the segment through an inlet for fluid feed exits the first membrane module through an outlet for fluid feed, and the complete amount of fluid feed exiting the first membrane module enters the inlet for fluid feed of the second membrane module, then a part of the fluid feed entering the second membrane module of the segment through the inlet for fluid feed exits the second membrane module through the outlet for fluid feed, and the complete amount of fluid feed exiting the second membrane module enters the inlet for fluid feed of the following membrane module, if such a membrane module exists, etc., and this procedure is repeated for all membrane modules being part of the segment. A part of the fluid feed entering a membrane module will in each membrane module enter into the permeate. The number of membrane modules in a segment and the number of segments in an apparatus will be determined by the desired capacity of the apparatus.

According to any embodiment of the invention, the membrane element may be a spiral wound membrane and may e.g. be made of polymer such as cellulose acetate, polyvinylidene fluoride, polyacrylonitrile, polypropylene, polysulfone, polyethersulfone.

According to any embodiments of the invention, an ATD allowing flow of permeate through a central opening of the ATD may be positioned between the membrane elements, if more than one membrane element is applied in one membrane module.

In the context of the present application an ATD allowing flow of permeate through a central opening of the ATD is referred to as a standard ATD.

According to any embodiment of the invention, at least one of the membrane modules is positioned above at least one of the other membrane modules, i.e. the fluid feed is pumped upwards when passing from one membrane module to a following membrane module.

According to any embodiment of the invention, the plurality of membrane modules may be positioned in layers of 2 or 3 or 4 or more on top of each other, i.e. the fluid feed is pumped upwards when passing through the plurality of membrane modules being part of same segment or same section.

According to any embodiment of the invention, at least one membrane module(s), optionally 2, 3, 4 or more or all membrane modules, may comprise a second inlet for a secondary fluid such as washing fluid e.g. water or diafiltration buffer which secondary fluid is added to the feed or retentate flow.

According to any embodiment of the invention, where a plurality of membrane modules is positioned in segments of 2 or 3 or 4 or more on top of each other, and the fluid feed is pumped upwards when passing through the plurality of membrane modules, and at least one layer of membrane modules, optionally 2, 3, 4 or more or all layers, each may comprise a second inlet for a secondary fluid such as washing fluid e.g. water or diafiltration buffer, the secondary fluid being added to the feed or retentate flow, and may optionally comprise a common feeding pipe for all membrane modules at one level.

According to a second aspect of the invention, the invention relates to a method for filtrating a liquid comprising the following step,

a) An amount of fluid feed is continuously pumped with pressure P_{B} through a loop comprising a multiplicity of n membrane modules which modules are serially connected, the fluid feed and permeate flow concurrently through each of the n membrane module(s),

b) generated permeate is continuously drained from each membrane module through a permeate outlet,

c) the permeate pressure or flow at the permeate outlet of each membrane module is controlled keeping TMP within a desired range, optionally the pressure is measured at the feed inlet end and/or at the outlet end of the membrane module,

d) optionally, to obtain a desired separation the number n of membrane modules which the fluid feed flows through may be varied either when designing the separation process or during the separation process i.e. the number of active membrane modules may be varied before or during operation.

That membrane modules are serially connected means that the outlet for fluid feed of the first membrane module is connected to the fluid inlet of the second membrane module, and if further membrane module(s) is/are present, the outlet for fluid feed of a previous membrane module (n−1) is connected to the fluid inlet of a following membrane module (n), and for the last membrane module (n), the outlet (3) for fluid feed is connected to the fluid inlet for fluid feed of the first membrane module.

According to an embodiment of the second aspect of the invention, a loop may comprise one or two or more Membrane module segment or a loop may comprise one or two or more Sections where a section is a parallel assembly of one or more membrane module segments.

According to any embodiment of the second aspect of the invention, a secondary fluid such as a diafiltration buffer may be added to at least one of the n membrane modules, optionally a secondary fluid such as a diafiltration buffer may be added to a plurality of membrane modules, optionally a secondary fluid such as a diafiltration buffer may be added to a plurality of segments of membrane modules at one or 2 or 3 or 4 or more levels or at all levels.

According to any embodiment of the second aspect of the invention, the pressure p₁ at the outlet of a first membrane module (1a) may be higher than the pressure p₂ at the outlet of a second membrane module (1b), and similar for the following membrane modules, i.e. p₁>p₂>p₃> . . . >pₙ.

According to any embodiment of the second aspect of the invention, the pressure at the inlet of the first membrane module may be in the area of 0.05-35 bar, e.g. at 0.1-25 bar or at 0.5-10 bar or at 2-4 bar, and/or the TMP may be in the area of 0.02-12 bar, e.g. 0.07-10 bar, or at 0.2-8 bar, or at 0.3-2 bar.

According to any embodiment of the second aspect of the invention, the base line pressure P_{BL} i.e. the pressure with which fluid feed is pumped into the loop, may be above 0.2 bar, or above 0.3 bar, or above 0.5 bar, or above 0.9 bar, or above 1.0 bar.

According to any embodiment of the second aspect of the invention, the booster pressure P_{B} may be above 0.1 bar per module in the loop or segment, i.e. P_{B}>n times 0.1 bar, or P_{B} may be above 0.2 bar, or above 0.3 bar, or above 0.4 bar, or above 0.5 bar, or above 0.6 bar, or above 0.9 bar, or above 1.0 bar per module in the loop or segment. The preferred booster pressure will depend on the application i.e. for which separation process the method is used.

According to any embodiment of the second aspect of the invention, the permeate pressure of each module Pₚₑᵣₘ is smaller than or equal to the pressure at the outlet of the module P_{OUT}, i.e. Pₚₑᵣₘ≤P_{OUT}, or e.g. Pₚₑᵣₘ≤P_{OUT}+0.5 bar.

According to any embodiment of the second aspect of the invention, the feed fluid may be a fluid in dairy industry or in dairy ingredients industry or in liquid food industry requiring accurate and same time control of TMP and cross flow, in particular the feed fluid can be feed for protein separation, fat separation, protein fractionation in dairy industry or dairy ingredients industry or liquid food industry, typically the fluid feed may be
dairy industry and dairy ingredients industry cheese whey or
dairy industry and dairy ingredients industry cheese whey WPC or
dairy industry and dairy ingredients industry skim milk or
dairy industry and dairy ingredients industry skim milk MPC or
dairy industry and dairy ingredients industry raw whole milk or
dairy industry and dairy ingredients industry whole milk or
dairy industry and dairy ingredients industry microfiltration permeates or
liquid food industry vegetable (green) protein solutions or
liquid food industry fish protein solutions or
liquid food industry meat protein solutions or
liquid food industry microfiltration permeates.

### BRIEF DESCRIPTION OF THE DRAWING

FIG. 1 illustrates a single prior art membrane module having counter-current flow in one membrane element;

FIG. 2 shows an embodiment of a membrane module of an apparatus according to the invention;

FIG. 3 shows an embodiment of an apparatus according to the invention comprising a segment having four membrane modules in series and a circulation loop for retentate;

FIG. 4 shows an embodiment of a filtration unit of an apparatus according to the invention comprising a section having four segments and having a matrix of 16 membrane modules;

FIG. 5 shows an embodiment of a filtration unit of an apparatus according to the invention comprising 2 sections having a matrix of 28 membrane modules;

FIG. 6 shows an embodiment of a filtration unit of an apparatus according to the invention comprising 1 section having a matrix of 32 membrane modules.

FIG. 7 shows an embodiment of a filtration unit of an apparatus according to the invention comprising 1 section having 16 membrane modules.

FIG. 8 illustrates a process carried out in an apparatus according to prior art comprising 10 membrane modules. The apparatus comprises one loop with 10 modules each comprising 1 element, the 10 modules being in hydraulic parallel connection on fluid feed/retentate side.

FIG. 9 illustrates a process carried out in an apparatus according to prior art comprising 1 membrane module. The apparatus comprises one loop with 1 module comprising 10 elements.

FIG. 10 illustrates a process carried out in an apparatus according to the invention comprising 10 membrane modules. The apparatus comprises one loop with 1 segment/section with 10 modules each comprising 1 element, the 10 modules being in hydraulic serial connection on fluid feed/retentate side.

Throughout the application identical or similar elements of different embodiments are given the same reference numbers.

### DETAILED DESCRIPTION OF INVENTION

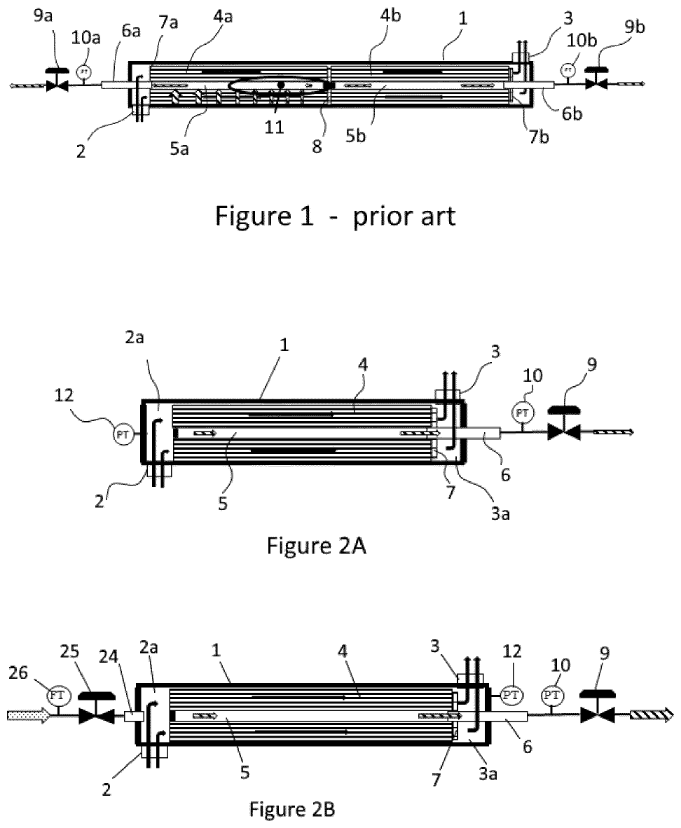

FIG. 1 shows an embodiment of a prior art membrane module which is used in the industry today.

The prior art membrane module 1 shown in FIG. 1 comprises a housing in which two membrane elements, a first membrane element 4a and second membrane element 4b, are positioned. The membrane elements 4a and 4b are spiral wound membranes which may be used for microfiltration or ultrafiltration. Feed or retentate flows through the membrane elements 4a and 4b in a direction from left to right, i.e. from a feed inlet 2 to a feed outlet 3, the permeate passes through the membrane elements 4a and 4b and ends up in a central tube 5a or 5b, either the permeate enters into the first central tube 5a having a permeate outlet 6a or into the second central tube 5b having a permeate outlet 6b. If the permeate ends up in the first central tube 5a the permeate flows in a direction from right to left i.e. counter current to the flow of feed or retentate in the first membrane element 4a, and if the permeate ends up in the second central tube 5b, the permeate flows in a direction from the left to the right, i.e. it flows concurrent to the flow of feed or retentate in the second membrane element 4b. Each central tube 5a and 5b for permeate is provided with a back-pressure valve 9a and 9b and possibly a pressure transmitter 10a and 10b which may be used to control the pressure in the permeate tube and therefore control the TMP in each membrane element. An ATD, respectively 8 and 7b, is positioned at least at the feed outlet end of each membrane element 4a and 4b, an ATD 7a may also be positioned at the permeate outlet end of the first membrane element 4a. The ATD 8 positioned at the feed outlet end of the first membrane element 4a is not a standard ATD as the ATD does not have a central opening, the central opening is closed to prevent the permeate obtained from the first membrane element 4a to flow into the central tube 5b of the second membrane element 4b.

According to the prior art membrane module, each membrane element is provided with pressure regulating means contrary to the present invention where each membrane module—no matter the number of membrane elements inside each housing—comprises a single permeate tube or central opening and a single outlet for permeate and therefore also a single means for regulating the pressure at the outlet of the permeate tube or central opening.

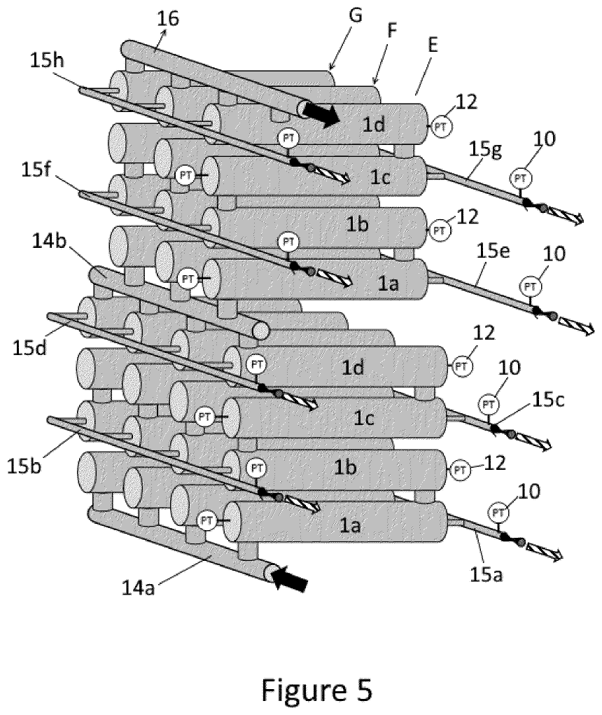

A complete facility or apparatus comprising prior art membrane module(s) will normally comprise a circulation pump forcing feed liquid through a plurality of parallelly positioned prior art membrane modules, i.e. each membrane module is fed directly from the pump and the permeate flowing from each membrane of each membrane module is collected into a common flow as illustrated in FIG. 5 in WO 2015/135545 for two membrane modules.

Also, as the first membrane element 4a is constructed having a permeate flow running countercurrent compared to the fluid feed flow, the permeate will face an increasing pressure and an increasing incoming flux as the permeate flow approaches the feed inlet 2 and the permeate outlet 6a. This feature causes a risk of an undefined flow behavior (possible dead leg 11) appearing in the central tube 5a closest to the central ATD 8, either during production or during cleaning. This is highly undesirable if the apparatus is used for separating food ingredients.

Also, it is necessary to use a non-standard component in form of the ATD 8 blocking transport of permeate between the membrane elements 4a and 4b, contrary to a standard operation where the ATD allows transport of permeate through a central opening of the ATD.

The present invention relates to an apparatus for cross-flow membrane filtration working at a low TMP and the apparatus comprises one or more segment(s) where each segment is constituted of a plurality of n membrane modules: 2, 3, 4, . . . , n. The membrane modules in one segment are serially connected on the fluid feed or retentate side, i.e. one segment has one inlet for fluid feed which fluid feed is forced through all membrane modules of the segment, whereas a plurality of segments may be either parallelly connected, i.e. each segment may have a separate inlet for fluid feed, or serially connected. The apparatus comprises a loop circulation pump forcing feed or retentate through one or more segment(s) of n membrane modules.

A single circulation pump may force the feed or retentate through a segment comprising a plurality of membrane modules, such as two membrane modules or a larger group of membrane modules e.g. 4 or 8 or 16 or 32 membrane modules, or all membrane modules of the apparatus. The maximum number nₘₐₓ of membrane modules in a loop is determined by the ability of the circulation pump to maintain an adequate pressure in all membrane modules and the ability to maintain a desired

TMP. To increase capacity, a single circulation pump may be replaced by a plurality of circulation pumps.

A membrane module positioned immediately downstream of a loop circulation pump is named the first membrane module 1a.

Embodiments of a single membrane module 1 of the present invention are shown in FIGS. 2A and 2B. The embodiment of a membrane module shown in FIG. 2A is without a second inlet for liquid whereas the embodiment of a membrane module shown in FIG. 2B has a second inlet for liquid.

Each membrane module 1 will normally only comprise one or two membrane elements 4, possibly up to 4 or up to 6 membrane elements during a microfiltration operation or an ultrafiltration operation.

Each membrane module 1 has one inlet 2 for fluid feed leading fluid feed to an inlet distribution chamber 2a and an outlet distribution chamber 3a wherefrom fluid feed is lead through one outlet 3 for fluid feed, one outlet for permeate 6 and a back-pressure control means 9 configured to control the pressure at the outlet for permeate 6. Each membrane module 1 may also comprise a pressure transmitter 10 which may be used to control the pressure at the permeate outlet 6, e.g. providing an automatic control procedure maintaining a constant pressure at the outlet or maintaining a constant TMP in the membrane module. Also, the feed-side of the membrane module 1 may optionally be provided with a pressure transmitter 12 either at the inlet distribution chamber 2a or at the outlet distribution chamber 3a for more precise control of the TMP, the presence of a pressure transmitter 12 will increase the likeliness of being able to maintain a constant TMP in a membrane module.

Each membrane element 4 may have a central tube or opening 5 configured to collect permeate and direct the permeate to the outlet for permeate 6, permeate may flow into the central opening 5 over the full length of the opening 5, and the opening 5 will be closed at the end facing the inlet distribution chamber 2a to prevent unfiltered retentate to enter the opening 5. A central opening 5 is e.g. provided when using a spiral wound membrane as membrane element 4. The outlet for permeate 6 is positioned at the same end of the membrane module 1 as the outlet 3 for fluid feed providing concurrent flow of fluid feed and permeate in the complete length of the membrane element 4 and the membrane module.

Optionally, a single membrane module 1 according to the present invention may comprise a second inlet 24 as illustrated in FIG. 2B, the second inlet 24 may be used to add washing liquid e.g. water or diafiltration buffer to the membrane module 1. The second inlet 24 may lead liquid into the inlet distribution chamber 2a or into the conduit ending at the fluid inlet 2. A membrane module 1 comprising a second inlet 24 may optionally comprise flow control means 25 e.g. in form of a valve controlling the flow through the second inlet 24. Also, a membrane module 1 comprising a second inlet 24 may optionally comprise a flow transmitter 26 which may allow for automatic control of the flow to the membrane module 1.

Although a membrane module 1 comprises a second inlet 24, liquid may not enter into the membrane module 1 through this second inlet 24. The flow of liquid through the second inlet 24 may be continuous or temporary or not take place at all during some operations.

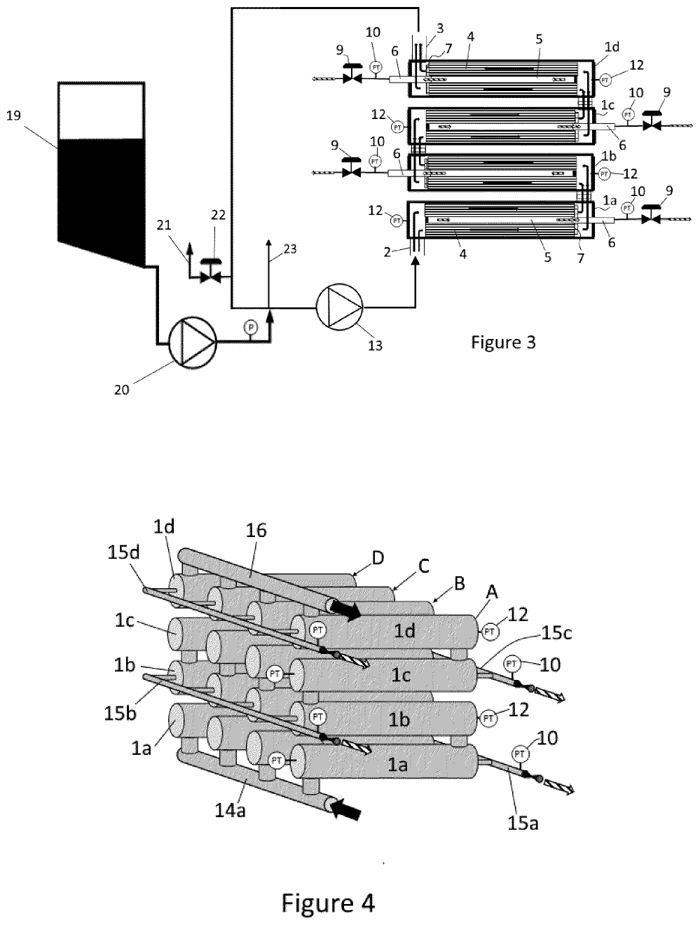

FIG. 3 disclose part of an apparatus comprising a segment with four membrane modules 1a, 1b, 1c, 1d. The outlet 3 for fluid feed of the first membrane module 1a is connected to the fluid inlet 2 of the second membrane module 1b, and if further membrane module(s) is/are present 1c, 1d, the outlet 3 for fluid feed of the previous membrane module (n−1) is connected to the fluid inlet 2 of the following membrane module (n), and for the last membrane module (n), the outlet 3 for fluid feed is connected to the inlet 2 for fluid feed of the first membrane module 1a normally via a circulation pump 13.

The apparatus comprises a storage unit 19 for fluid feed or retentate, the storage unit 19 may be constituted of one or more tanks or containers which may provide a continuous flow of feed or retentate or a mixture between feed and retentate into the membrane modules. A pump 20 e.g. together with a not shown control device such as a frequency converter or valve may control the inlet of retentate or fluid feed to fluid flow recirculating through the membrane modules 1a-1d.

A loop of recirculating retentate may be provided with an outlet 21 for retentate, the outlet for retentate may be controlled by a valve 22. The outlet for retentate may be positioned upstream of the inlet for new retentate from the storage unit 19. However, if the loop shown in FIG. 3 is the first loop in a series of filtration loops providing a further reduction in material content of the circulating fluid, then the loop may be provided with an outlet 23 directing a fraction of the circulating fluid to a second loop, following there might be up to 16 or 20 loops. If a portion of the circulating fluid is directed to a second loop, then the loop shown in FIG. 3 will normally not be provided with an outlet 21 for retentate. The loop shown in FIG. 3 may be the first loop in a series of loops each comprising an outlet 23 directing circulating fluid to the next loop, in this case normally only the last loop in the series will be provided with an outlet 21 for retentate.

I.e. the membrane modules 1a, 1b, 1c, 1d are serially connected at the fluid side of the membrane modules 1a, 1b, 1c, 1d, i.e. the same flow of fluid enters all membrane modules although the amount is reduced by the amount of permeate leaving for each membrane module. The permeate is removed from each membrane module 1 and may be collected in a joint flow of permeate. The membrane modules 1a, 1b, 1c, 1d provide a segment in a loop through which feed or retentate may be continuously pumped by the circulation pump 13 until a desired amount of permeate has been removed via the permeate outlets 6 of the membrane modules.

As it is possible to control the pressure in each membrane module it is possible to overcome static pressure and therefore it is possible to design a matrix comprising a number of segments of membrane modules 1 in two dimensions i.e. it is not necessary to position the membrane modules 1 at the same level, instead membrane modules 1 being serially connected on the feed or retentate side, may be positioned on top of each other providing vertically extending segments. Traditionally, matrices of membrane modules are placed beside each other i.e. at the same level to prevent the static pressure from influencing the TMP and therefore the filtration process.

Also, as the permeate is removed from the end of the permeate tube 5 having the lowest pressure on the feed or retentate side, the risk of creating dead pockets during filtration or cleaning of the equipment is eliminated.

FIG. 4 discloses an embodiment of an apparatus according to the invention comprising a matrix of 16 membrane modules (n=16).

This embodiment comprises 4 segments A, B, C, D of four membrane modules 1 positioned beside each other and each segment comprises four membrane modules 1a, 1b, 1c, 1d placed on top of each other. The connections between the membrane modules of a segment comprising 4 membrane modules may be as shown in FIG. 3.

In the embodiment shown in FIG. 4, the four segments are identical, however, as permeate is drained from the fluid feed or retentate at each level, the number of membrane modules or the number of membrane elements at an upper level may be reduced.

In prior art, segments of membrane modules may be serially connected on the fluid feed side, but if this is the case, then the serially connected membrane modules are normally positioned at the same vertical level, i.e. the serially connected membrane modules are placed beside each other, particularly if the demand for a constant and/or low TMP is high. Also, a segment would normally only comprise a few membrane modules, e.g. a maximum of two membrane modules.

In the shown embodiment of the present invention, the membrane modules 1a, 1b, 1c, 1d in each segment are placed on top of each other and the membrane modules are serially connected at the feed side of the membrane module, i.e. the fluid feed or retentate exiting the last membrane module 1d also entered the first membrane module 1a of the segment. The four segments each comprising vertically aligned membrane modules are fed with fluid feed or retentate from a common feeding pipe 14a which is normally fed by a single pump or a pumping system.

When using a constant pressure pump, the static pressure pₛᵢ in the feeding pipe 14a may be kept constant.

From the feeding pipe 14a, the fluid feed flows into each of first membrane modules 1a in each of the segments A, B, C and D, the fluid feed is then forced through the following membrane modules 1b, 1c, and 1d. In each segment the fluid feed or retentate is collected in the feed outlet pipe 16 wherefrom fluid feed or retentate normally is recirculated to the feeding pipe 14a of the filtration apparatus by a not shown circulation pump. To maintain a continuous process, a flow of new fluid feed is normally added to the fluid feed circulation loop between the outlet pipe 16 and the feeding pipe 14a. Also, a flow of fluid feed or retentate may be removed from the recirculating flow, either as a product or to a second filtration loop, to maintain a desired yield of product.

The permeate flowing from the permeate outlets of each membrane module level are collected in outlet permeate pipes 15a, 15b, 15c and 15d, i.e. the first membrane module 1a of each segment A, B, C and D, has a common outlet permeate pipe 15a, the second membrane module 1b of each segment A, B, C and D, has a common outlet permeate pipe 15b, the third membrane module 1c of each segment A, B, C and D, has a common outlet permeate pipe 15c and the fourth membrane module 1d of each segment A, B, C and D, has a common outlet permeate pipe 15d. A pressure transmitter 10 is positioned in each permeate outlet pipe 15a, 15b, 15c and 15d downstream of the last permeate outlet, as the membrane modules 1 of each level a, b, c or d, are positioned at the same height and as the outlet permeate pipes 15 are horizontal, the pressure is assumed constant in the full length of each outlet permeate pipe and therefore a single common pressure transmitter 10 and a single common back pressure valve for each outlet permeate pipe may provide for proper control of the pressure in each membrane module.

In general, the number of membrane modules 1 being vertically aligned in a segment may be from 2-16, normally between 2-12, e.g. between 2-8, and the number of segments of vertically aligned membrane modules may be from 1-32, e.g. between 2-32 or between 4-16. The optimum number of membrane modules in the vertical dimension as well as the optimum number of sets of vertically aligned membrane modules will depend on the pump capacity and area available for the filtration facility.

FIG. 5 discloses an embodiment of an apparatus according to the invention comprising a double matrix of 16+12 membrane modules. The embodiment may comprise the same elements as the embodiments shown in FIGS. 2 and 3.

This embodiment comprises a first section of 4 segments A, B, C, D of four membrane modules 1 positioned beside each other, each segment comprises four membrane modules 1a, 1b, 1c, 1d as the embodiment of FIG. 4. To increase the capacity of the apparatus compared to the apparatus of FIG. 4, a second section comprising 3 vertically extending segments E, F, G of each four membrane modules 1a, 1b, 1c, 1d has been placed on top of the first section.

The first or lower section of the embodiment comprises the same elements as the embodiment of FIG. 4, however the feed outlet of the embodiment of FIG. 4 is replaced with a manifold 14b having four inlets receiving fluid feed from each of the lower section segments A, B, C and D, and three outlets distributing fluid feed to the three upper section segments E, F and G.

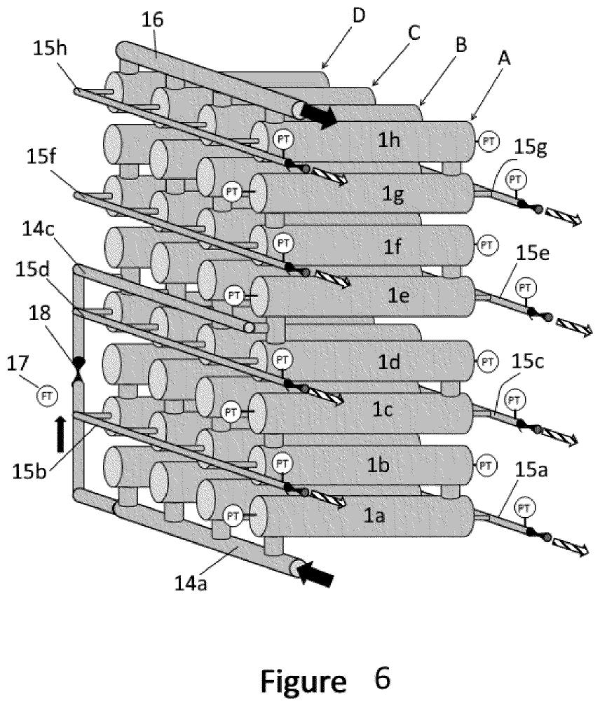

FIG. 6 discloses an embodiment of an apparatus according to the invention comprising one matrix of respectively 32 membrane modules.

This embodiment comprises one section of 4 segments A, B, C, D of eight membrane modules 1 positioned beside each other, each segment comprises eight membrane modules 1a, 1b, 1c, 1d, 1e, 1f, 1g, 1h. The embodiment may comprise the same elements as the embodiments shown in FIGS. 2 and 3.

To provide an optimized flow of fluid feed into the membrane modules positioned at the top or upper half of the segments, a supply of feed fluid may be distributed directly to membrane modules at the top or upper half of the segments, e.g. via a supply pipe 14c. The flow to the supply pipe 14c may be controlled by a flow transmitter 17 and a valve 18. The fluid feed to the supply pipe 14c may be distributed by the same pump or pumping system supplying the fluid feed to the first membrane module 1a of each segment A, B, C and D.

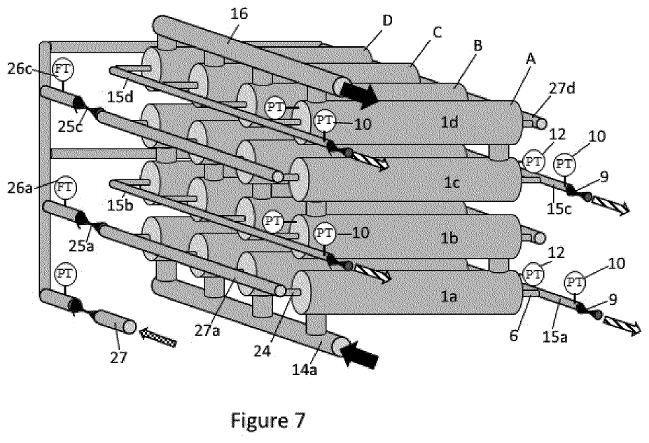

FIG. 7 discloses an embodiment of an apparatus according to the invention comprising a matrix of 16 membrane modules (n=16).

This embodiment—like the embodiment of FIG. 4—comprises four segments A, B, C, D and each segment A, B, C and D comprises four membrane modules 1a, 1b, 1c, 1d. The connections between the membrane modules of one segment may be as shown in FIG. 3.

In the embodiment shown in FIG. 7, the four segments are identical, permeate is drained from the fluid feed or retentate from a permeate outlet 6 of each membrane module and collected into a single flow at each membrane module level a, b, c and d, also, each membrane module comprises a second inlet 24 at the feed-inlet end of the membrane module.

In the shown embodiment, the membrane modules 1a, 1b, 1c, 1d of each segment are placed on top of each other, where the membrane modules 1a are lowest and the membrane modules 1d are at the top. The membrane modules within a segment A, B, C and D are serially connected at the feed side of the membrane modules, i.e. the fluid feed or retentate exiting the last membrane module 1d may be pumped to the first membrane module 1a of either the same segment or to a common feed container receiving circulating feed or retentate from all four segments.

The four segments A, B, C, D each comprise vertically aligned membrane modules which may be fed with fluid feed or retentate from a common feeding pipe 14a, the feeding pipe 14a may be fed by a single pump or by a pumping system.

Also, each membrane module at each level 1a, 1b, 1c or 1d may be fed with secondary liquid through a common feeding pipe for each level 27a, 27b, 27c or 27d. Each of the common feeding pipes for secondary liquid 27a, 27b, 27c or 27d may comprise inlet control means e.g. comprising an inlet valve 25a, 25b, 25c and 25d for each level (25b and 25d are not shown on FIG. 7 as they are hidden behind the apparatus), e.g. in combination with a flow transmitter 26a, 26b, 26c, 26d (26b and 26d are not shown on FIG. 7 as they are hidden behind the apparatus). In the shown embodiment all levels comprise a common inlet for secondary fluid, it is however optional to feed all levels with secondary liquid, i.e. some levels may not be supplied with secondary liquid. E.g. the first and the last level of membrane modules may not be fed with secondary fluid, in the embodiment of FIG. 7 this would be the first level (1a) and the fourth level (1d).

When using a constant pressure pump system, the static pressure pₛᵢ in the feeding pipe 14a may be kept constant.

From the feeding pipe 14a, the fluid feed flows into each of first membrane modules 1a, i.e. the first level a, in each of the segments A, B, C and D, the fluid feed is then forced through the following membrane modules 1b, 1c, and 1d. From the last membrane module 1d of each segment the fluid feed or retentate is collected in the feed outlet pipe 16 wherefrom fluid feed or retentate normally is recirculated to the feeding pipe 14a of the filtration apparatus by a not shown circulation pump. To maintain a continuous process, a flow of new fluid feed may be added to the fluid feed circulation loop between the outlet pipe 16 and the feeding pipe 14a. Also, a flow of fluid feed or retentate may be removed from the recirculating flow, either as a product or to a second filtration loop, to maintain a desired yield of product.

The permeate flowing from the permeate outlets of each membrane module level are collected in outlet permeate pipes 15a, 15b, 15c and 15d, i.e. the first membrane module 1a of each segment A, B, C and D, has a common outlet permeate pipe 15a, the second membrane module 1b of each segment A, B, C and D, has a common outlet permeate pipe 15b, the third membrane module 1c of each segment A, B, C and D, has a common outlet permeate pipe 15c and the fourth membrane module 1d of each segment A, B, C and D, has a common outlet permeate pipe 15d. Compared to the embodiment of FIG. 4 where no secondary fluid is added, the amount of permeate will have increased as the majority of secondary fluid normally passes through the filter and ends up in the permeate fraction.

A pressure transmitter 10 is positioned in each permeate outlet pipe 15a, 15b, 15c and 15d downstream of the last permeate outlet, as the membrane modules 1 of each level a, b, c or d, are positioned at the same height and as the outlet permeate pipes 15 are horizontal, the pressure is assumed constant in the full length of each outlet permeate pipe and therefore a single common pressure transmitter 10 and a single common back pressure valve for each outlet permeate pipe may provide for proper control of the pressure in each membrane module.

A pressure transmitter 12 is positioned at the outlet distribution chamber 3a at each membrane module or at each level i.e. a, b, c, d, . . . in a section, to improve the possibility for controlling the TMP at each level and thereby control the separation process.

In general, the number of membrane modules 1 being vertically aligned in a segment may be from 2-16, normally between 2-12, e.g. between 2-8, and the number of segments of vertically aligned membrane modules may be from 1-32, e.g. between 2-32 or between 4-16. The optimum number of membrane modules in the vertical dimension as well as the optimum number of sets of vertically aligned membrane modules will depend on the pump capacity and area available for the filtration facility.

In general, an apparatus according to the present invention may comprise one or more matrices of membrane modules. Each matrix comprises one or more segments of vertically displaced and/or aligned membrane modules which are serially connected in respect of fluid feed, i.e. the fluid feed which enters the first membrane module flows through all membrane modules of the segment and will either be removed as fluid feed from an outlet of the last membrane module of the segment or be removed as permeate from permeate outlets of one of the membrane modules comprised in the segment. If a matrix comprises more than one segment, the fluid feed may be distributed in parallel to the segments through a common feeding pipe which feeding pipe is connected to a source of feeding fluid and a constant pressure pump forcing the feeding fluid into the feeding pipe and through the segments of membrane modules. If the apparatus comprises more than one matrix of membrane modules, each matrix may be referred to as a section, and a second or following sections may be positioned on top of a first or lower section, the fluid feed flow from a first or lower section may be connected to a second or upper section through a manifold having a number of inlets corresponding to the number of segments in the lower section and a number of outlets corresponding to the number of segments in the upper section. If a segment comprises more than 2 or 3 or 4 membrane modules displaced and/or aligned in a vertical direction, where the lowest membrane module is considered the first membrane module, then a supply of fluid feed may be added to the third or fourth or fifth membrane module, respectively, e.g. through a supply pipe which may distribute fluid feed to more than one segment of membrane modules. Also, a series of membrane modules at a same vertical level and fed by the same pump or pumping system, may have an permeate outlet feeding permeate into a common outlet permeate pipe which is provided with a common pressure transmitter and back pressure valve.

Description of method for filtration of a liquid

The apparatus of the present invention is primarily directed to use within food production as the apparatus provides a high sanitary level by avoiding dead legs in the apparatus structure.

Also, as the apparatus only use standard components it is less expensive and less complex than apparatus using non-standard components.

The apparatus and the method according to the invention are particularly suitable for microfiltration, or processes of ultrafiltration facing the same problems as microfiltration. Microfiltration, and some ultrafiltration processes, works at a very low TMP, and it is difficult to optimize the cross flow while maintaining a constant low TMP through a series of inter-connected membrane elements whether these membrane elements are positioned in a single membrane module or a series of membrane modules. The pressure at the inlet of the fluid feed is determined by the settings of the pump, and it is possible to control the pressure on the permeate side of the membrane module by positioning a back-pressure valve at the permeate outlet. According to the present invention the pressure in a series of membrane modules through which membrane modules fluid feed is pumped in a loop is adapted to the decrease in pressure occurring in the fluid feed as the distance between a membrane module and the pump is increased in the flow direction of the fluid feed.

In general, the present invention relates to a method for filtrating a liquid in an apparatus for membrane filtration comprising the following step,
a) An amount of fluid feed wherefrom a permeate is separated is continuously pumped through a loop comprising a multiplicity of membrane modules, each membrane module being provided with one inlet and one outlet for fluid feed/retentate and permeate respectively, the inlet for the fluid feed/retentate is positioned at the opposite end of the membrane module as the outlets for respectively the fluid feed/retentate and the permeate, ensuring that the flows of fluid feed/retentate and the permeate are concurrent in the full lengths of the membrane(s) in each membrane module. This causes a well-defined flow behavior inside the membrane module without appearance of a dead leg in the central tube of the membrane.

b) generated permeate is continuously drained from each membrane module through the permeate outlet,
c) the permeate pressure at the permeate outlet in each membrane module is controlled keeping TMP within a desired range, optionally the pressure is also measured at the feed inlet end of the membrane module,
d) optionally, to obtain an optimized separation the number of membrane modules which the fluid feed flows through is varied either when designing the separation process or during the separation process.

During microfiltration or ultrafiltration, the TMP may be in the area of 0.02-12 bar, e.g. 0.07-10 bar, or 0.2-8 bar, or 0.3-2 bar.

The method of the present invention can be used in connection with membrane filtration operations within the dairy industry. E.g. the feed fluid can be a fluid in the dairy industry and dairy ingredients industry requiring accurate and same-time control of TMP and cross flow to obtain the result in particular protein separation, fat separation, micro-organism separation and protein fractionation on
cheese whey
cheese whey WPC (whey protein concentrate)
skim milk
skim milk MPC (milk protein concentrate)
raw whole milk
whole milk
microfiltration permeates

Also, method of the present invention can be used in connection with membrane filtration operations within a fluid in the
liquid food industry or
liquid beverage industry or
liquid life Science industry

requiring accurate and same-time control of TMP and cross flow to obtain the result in
protein separation or
fat separation or
micro-organism separation or
protein fractionation or
alcohol separation

on
vegetable (green) solutions or
meat solutions or
fish solutions or
beverage solutions or
microfiltration permeates.

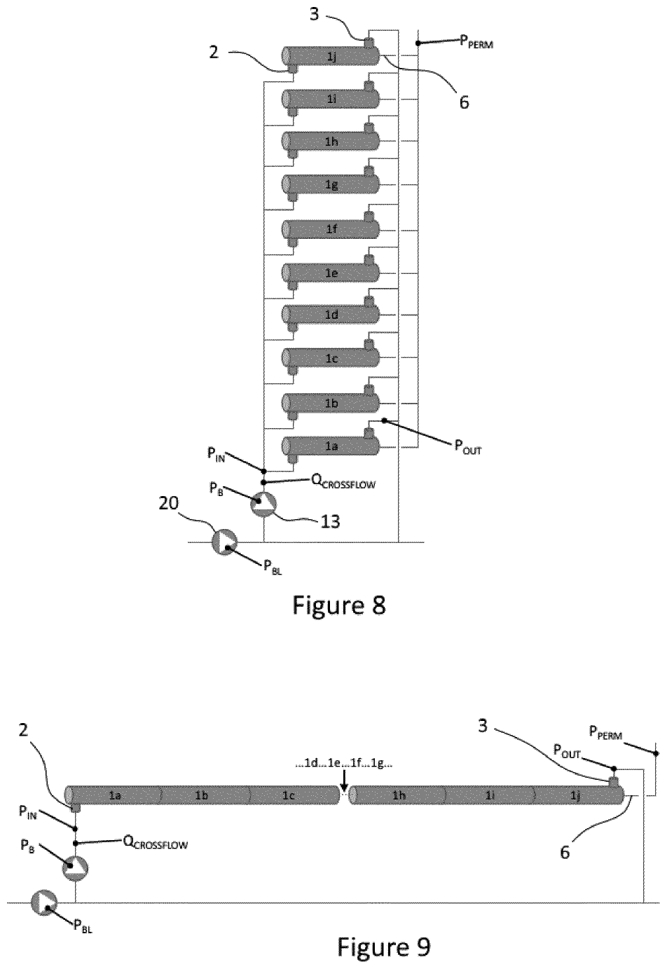

FIG. 8 illustrates a process carried out in an apparatus according to prior art comprising 10 membrane modules 1a, 1b, . . . , 1j. The apparatus comprises one loop comprising 10 modules and each module comprises 1 membrane element, the 10 modules are parallelly connected on the fluid feed/retentate side. Fluid feed/retentate are circulated in the loop by recirculation pump 13, the circulation pump provides a booster pressure P_{B}.

This build is according to prior art the prevalent method for achieving the lowest possible TMP per membrane element same time with the highest possible cross flow.

In this process example the dP/element is set to 0.5 bar and at traditionally 0 bar in pₚₑᵣₘ.

Q_{CROSSFLOW} is the volumetric flow (m³/h) in the loop after the circulation pump 13, the volumetric flow downstream of the modules are lower as permeate is removed in the modules, additional feed is added to the loop by the feed pump 20.

The membrane modules are positioned in a parallel structure receiving fluid feed/retentate at the same pressure P_{IN}. The base line pressure P_{BL} provided by the feed pump 20 of this system is set to 0.3 bar in order to minimize TMP. The pressure at the inlet of each membrane module is the same for all 10 membrane modules i.e. the inlet pressure P_{IN} is the sum of the base line pressure P_{BL} and the booster pressure P_{B}, which in the example is 0.3+0.5=0.8 bar.

The system is difficult to control because it may be under influence from differences in static head i.e. differences in geographic height may influence on the desired low and uniform TMP per membrane element. Also, the system is influenced by the base line pressure, P_{BL}, which has to be sufficiently high to avoid damaging cavitation in the circulation pump(s) which in some cases can have a negative effect on TMP, but also sufficiently low in order to obtain a desired low TMP.

The flow Q_{CROSSFLOW} through the booster pump or recirculation pump 13 is high as the recirculation pump 13 delivers equal amounts of fluid to all 10 membrane modules 1a-1j. A high flow through the recirculation pump, means that the installation has a relatively high consumption of energy and therefore this apparatus is relatively expensive to operate.

TABLE 1
Q_{CROSSFLOW} = Index 1000 FIG. 8

| Module | Pᵢₙ | Pₒᵤₜ | Pₚₑᵣₘ | TMP | |
|---|---|---|---|---|---|
| 1a | 0.8 | 0.3 | 0 | 0.55 | = (0.8 + 0.3)/2 − 0 |
| 1b | 0.8 | 0.3 | 0 | 0.55 | = (0.8 + 0.3)/2 − 0 |
| 1c | 0.8 | 0.3 | 0 | 0.55 | = (0.8 + 0.3)/2 − 0 |
| 1d | 0.8 | 0.3 | 0 | 0.55 | = (0.8 + 0.3)/2 − 0 |
| 1e | 0.8 | 0.3 | 0 | 0.55 | = (0.8 + 0.3)/2 − 0 |
| 1f | 0.8 | 0.3 | 0 | 0.55 | = (0.8 + 0.3)/2 − 0 |
| 1g | 0.8 | 0.3 | 0 | 0.55 | = (0.8 + 0.3)/2 − 0 |
| 1h | 0.8 | 0.3 | 0 | 0.55 | = (0.8 + 0.3)/2 − 0 |
| 1i | 0.8 | 0.3 | 0 | 0.55 | = (0.8 + 0.3)/2 − 0 |
| 1j | 0.8 | 0.3 | 0 | 0.55 | = (0.8 + 0.3)/2 − 0 |

FIG. 9 illustrates a process carried out in an apparatus according to prior art comprising one membrane module. The apparatus comprises one loop with one module and the one module comprises ten membrane elements. The module has a single outlet for permeate where permeate separated from all ten membrane elements of the one membrane housing is removed.

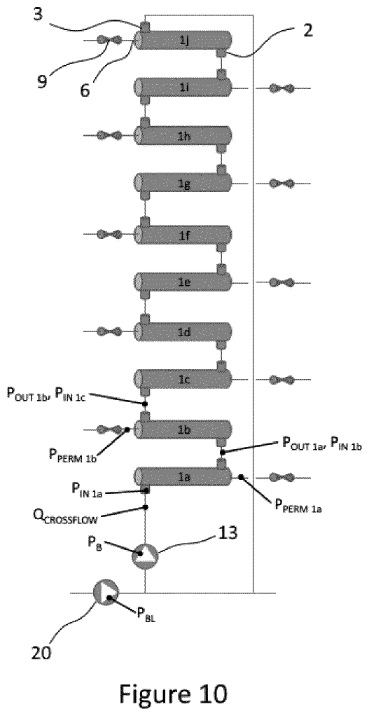

Inside the one module, the membrane elements are positioned in an end-to-end structure receiving fluid feed/retentate feed at different pressures corresponding to dP/element. The numbering 1a, 1b, . . . , 1j is applied, although this embodiment only comprises a single module according to the definition of a module of this specification, to illustrate that the number of membrane elements are the same as in the prior art example of FIG. 8 and the embodiment of FIG. 10.

In the process example the dP/element is set to 0.5 bar and at traditionally 0 bar in pₚₑᵣₘ. The base line pressure P_{BL} provided by the feed pump 20 of this system is set to 0.3 bar in order to minimize TMP. The pressure into the membrane module is the sum of the base line pressure P_{BL} and the booster pressure P_{B}, which in the example is 0.3+5=5.3 bar.

As the below Table 2 clearly indicates it is for an apparatus of this configuration or a similar configuration with fewer membrane elements, not possible to maintain the same and low TMP per membrane element, however, the index figure Q_{CROSSFLOW} is 100, a factor 10 lower than for the prior art example of FIG. 8. As below table 2 illustrates, it is according to this prior art example impossible to obtain a constant low TMP if the number of membrane elements in a module is two or higher, if an example instead of ten membrane elements comprised two membrane elements the TMP would be as for 1i and 1j.

TABLE 2
Q_{CROSSFLOW} = Index 100 FIG. 9

| Module | Pᵢₙ | Pₒᵤₜ | Pₚₑᵣₘ | TMP | |
|---|---|---|---|---|---|
| 1a | 5.3 | 4.8 | 0 | 5.05 | = (5.3 + 4.8)/2 − 0 |
| 1b | 4.8 | 4.3 | 0 | 4.55 | = (4.8 + 4.3)/2 − 0 |
| 1c | 4.3 | 3.8 | 0 | 4.05 | = (4.3 + 3.8)/2 − 0 |
| 1d | 3.8 | 3.3 | 0 | 3.55 | = (3.8 + 3.3)/2 − 0 |
| 1e | 3.3 | 2.8 | 0 | 3.05 | = (3.3 + 2.8)/2 − 0 |
| 1f | 2.8 | 2.3 | 0 | 2.55 | = (2.8 + 2.3)/2 − 0 |
| 1g | 2.3 | 1.8 | 0 | 2.05 | = (2.8 + 1.8)/2 − 0 |
| 1h | 1.8 | 1.3 | 0 | 1.55 | = (1.8 + 1.3)/2 − 0 |
| 1i | 1.3 | 0.8 | 0 | 1.05 | = (1.3 + 0.8)/2 − 0 |
| 1j | 0.8 | 0.3 | 0 | 0.55 | = (0.8 + 0.3)/2 − 0 |

In the great majority of filtration processes requiring a low TMP, a system according to FIG. 9 will not separate as desired due to fast fouling of the membrane surfaces and same time altering membrane characteristics to a tighter membrane retaining substances which during a filtration operation were intended to pass through the membrane into the permeate.

FIG. 10 illustrates a process carried out in an apparatus according to the invention comprising ten membrane modules. The apparatus comprises one loop comprising one segment or section with ten modules each module comprising one membrane element, the ten modules are in hydraulic serial connection on fluid feed/retentate side. The modules of the apparatus of FIG. 10 corresponds to a segmentation of the single module of FIG. 9, the segmentation or splitting up of the single module to a series of modules each comprising one membrane element, makes it possible to perform an individual control of each membrane element, and the apparatus as shown in FIG. 10 may overcome the problems experienced with the apparatuses shown in FIGS. 8 and 9.

In the process example of FIG. 10, the pressure loss dP per membrane module is set to 0.5 bar.

The pressure difference between fluid feed/retentate and permeate at the outlet end of a membrane module is set to 0.1 bar.

The base line pressure P_{BL} provided by the feed pump 20 is set to 1 bar. The base line pressure P_{BL} is the pressure at which the fluid feed is directed to the circulating fluid feed or retentate, and there is a limit to how low this pressure may be due to risk of cavitation in the circulation pump(s) and it suits commercially available pumps better than a very low pressure at needed volumetric capacities.

The circulation pump 13 is set to increase or boost the pressure P_{B} by 5 bar. In general, the pressure to be provided by the circulation pump is determined by the need for dP/element and by the number of serially and parallel connected membrane modules/elements, the used membranes etc. (p_{out,1j}=P_{BL})

The permeate pressure Pₚₑᵣₘ is controlled for each module thereby establishing a desired TMP for each membrane element in each module. By this method it is possible to maintain a low and constant TMP at each membrane modules at a reasonable cost.

In order to obtain a desired flux and permeation through membrane elements over long time, it is necessary to maintain for the application a suitable cross flow—high or low—, the cross flow being the flow along the surface of the membrane on the retentate side. The cross flow minimizes accumulation of material on the surface of the membrane. The cross flow through each membrane module 1a, 1b, . . . , 1j corresponds to the recirculated fluid minus the permeate being drained from upstream membrane modules plus possible added diafiltration water.

TABLE 3
Q_{CROSSFLOW} = Index 100 FIG. 10

| Module | Pᵢₙ | Pₒᵤₜ | Pₚₑᵣₘ | TMP | |
|---|---|---|---|---|---|
| 1a | 6.0 | 5.5 | 5.4 | 0.35 | = (6.0 + 5.5)/2 − 5.4 |
| 1b | 5.5 | 5.0 | 4.9 | 0.35 | = (5.5 + 5.0)/2 − 4.9 |
| 1c | 5.0 | 4.5 | 4.4 | 0.35 | = (5.0 + 4.5)/2 − 4.4 |
| 1d | 4.5 | 4.0 | 3.9 | 0.35 | = (4.5 + 4.0)/2 − 3.9 |
| 1e | 4.0 | 3.5 | 3.4 | 0.35 | = (4.0 + 3.5)/2 − 3.4 |
| 1f | 3.5 | 3.0 | 2.9 | 0.35 | = (3.5 + 3.0)/2 − 2.9 |
| 1g | 3.0 | 2.5 | 2.4 | 0.35 | = (3.0 + 2.5)/2 − 2.4 |
| 1h | 2.5 | 2.0 | 1.9 | 0.35 | = (2.5 + 2.0)/2 − 1.9 |
| 1i | 2.0 | 1.5 | 1.4 | 0.35 | = (2.0 + 1.5)/2 − 1.4 |
| 1j | 1.5 | 1.0 | 0.9 | 0.35 | = (1.5 + 1.0)/2 − 0.9 |

Table 3 shows the effect of the present invention in terms of being able to provide
Very low and equal TMP in each membrane element
Energy savings; Q_{CROSSFLOW} index 100 versus 1000 in FIG. 8, prior art method, Table 1.

Thus, to reiterate, the present invention pertains to an apparatus and a method for cross-flow membrane filtration which may be used for filtration processes requiring a controllable low Transmembrane Pressure (TMP) and at the same time a controllable high cross-flow. This may be the case both for microfiltration and for ultrafiltration processes. Particularly, the apparatus is directed to use in preparation of food ingredients where fractionating is required. An apparatus comprises a plurality of n membrane modules (2, . . . , n) and a pump, where the membrane module (1) positioned immediately downstream of the pump is named the first membrane module (1a), each membrane module (1) comprises at least one membrane element (4), one inlet (2) for fluid feed and one outlet (3) for fluid feed, one outlet for permeate (6), and a back-pressure control means (9) such as a valve configured to control the pressure and/or the flow at the outlet for permeate (6), each membrane element (4) has a central opening (5) configured to collect permeate and direct the permeate to the outlet for permeate (6), which outlet for permeate (6) is positioned at the same end of the membrane module (1) as the outlet (3) for fluid feed providing concurrent flows in fluid feed and permeate in full length of each membrane module (1). The outlet (3) for fluid feed of the first membrane module (1a) is connected to the fluid inlet (2) of the second membrane module (1b), and if further membrane module(s) is/are present, the outlet (3) for fluid feed of a previous membrane module (n−1) is connected to the fluid inlet (2) of a following membrane module (n), and for the last membrane module (n), the outlet (3) for fluid feed is connected to the fluid inlet (2) for fluid feed of the first membrane module (1a). A method comprises the following steps a), b) and c): a) An amount of fluid feed is continuously pumped with pressure PB through a loop comprising a multiplicity of n membrane modules which modules are serially connected, the fluid feed and permeate flow concurrently through each of the n membrane module(s), b) generated permeate is continuously drained from each membrane module through a permeate outlet, c) the permeate pressure at the permeate outlet of each membrane module is controlled keeping TMP within a desired range.

| Ref. no. | Ref. name |
|---|---|
| 1, 1a, 1b, 1c, | Membrane module |
| 1d, . . . , 1n | |
| 2, 2a | Inlet for feed/retentate, inlet distribution chamber |
| 3, 3a | Outlet for feed/retentate, outlet distribution |
| | chamber |
| 4, 4a, 4b | Membrane element |
| 5 | Central tube or opening of membrane element |
| 6 | Outlet for permeate |
| 7, 7a, 7b | Standard ATD |
| 8 | Non-standard ATD of prior art |
| 9, 9a, 9b | Back pressure valve at permeate outlet |
| 10 | Pressure transmitter at permeate outlet of |
| | membrane |
| 11 | Dead pocket of prior art |
| 12 | Pressure transmitter at fluid feed inlet of membrane |
| 13 | Fluid feed/retentate recirculation pump |
| 14a, 14b, 14c | Feeding pipe for segment comprising a plurality of |
| | membrane modules |
| 15a, 15b, | Outlet permeate pipes |
| 15c, . . . , 15h | |
| 16 | Feed outlet pipe |
| 17 | Flow transmitter |
| 18 | Feed flow control valve |
| 19 | Storage unit |
| 20 | Feed pump |
| 21 | Retentate outlet |
| 22 | Retentate outlet valve |
| 23 | Fluid feed/retentate outlet to a downstream or |
| | secondary loop |
| 24 | Second inlet |
| 25, 25a, 25b, | Flow control means |
| 26c, 26d | |
| 26, 26a, 26b, | Flow transmitter |
| 26c, 26d | |
| 27, 27a, 27b, | Common feeding pipe for secondary fluid for two or |
| 27c, 27d | more segments |

1. Apparatus for cross-flow membrane filtration comprising a plurality of n membrane modules (2, . . . , n) and a pump, where a membrane module (1) positioned immediately downstream of the pump is named a first membrane module (1a),
each membrane module (1) comprises at least one membrane element (4), one inlet (2) for fluid feed and one outlet (3) for fluid feed, one outlet for permeate (6), and a back-pressure control means (9) configured to control pressure, flow, or pressure and flow at the outlet for permeate (6),
each membrane element (4) has a central opening (5) configured to collect permeate and direct the permeate to the outlet for permeate (6), which outlet for permeate (6) is positioned at a same end of the membrane module (1) as the outlet (3) for fluid feed providing concurrent flows in fluid feed and permeate in full length of each membrane module (1),
wherein the outlet (3) for fluid feed of the first membrane module (1a) is connected to the fluid inlet (2) of the second membrane module (1b), and if one or more further membrane modules are present, the outlet (3) for fluid feed of a previous membrane module (n−1) is connected to the fluid inlet (2) of a following membrane module (n), and for the last membrane module (n), the outlet (3) for fluid feed is connected to the fluid inlet (2) for fluid feed of the first membrane module (1a).

2. The apparatus according to claim 1, wherein each membrane module (1) comprises a maximum of four or of six membrane elements, wherein each membrane module comprises one, two or three membrane elements (4).

3. The apparatus according to claim 1, wherein n≥2, or n≥4, or n≥8, or 2≤n≤40, or 2≤n≤36, or 4≤n≤32.

4. The apparatus according to claim 1, wherein an anti-telescoping device (ATD) allowing flow of permeate through a central opening of the anti-telescoping device is positioned between the membrane elements, if more than one membrane element is applied in one membrane module.

5. The apparatus according to any previous claims, wherein at least one of the membrane modules is positioned above at least one of the other membrane modules, so that the fluid feed is pumped upwards when passing from one membrane module to the following membrane module.

6. The apparatus according to claim 1, wherein the plurality of membrane modules is positioned in layers of 2 or 3 or 4 or more on top of each other, so that the fluid feed is pumped upwards when passing through the plurality of membrane modules.

7. The apparatus according to claim 1, wherein at least one membrane module, optionally 2, 3, 4 or more or all membrane modules, comprises a second inlet (24) for a secondary fluid comprising washing fluid or a diafiltration buffer which secondary fluid is added to the feed or retentate flow.

8. The apparatus according to claim 1, wherein a plurality of membrane modules is positioned in segments of 2 or 3 or 4 or more on top of each other, so that the fluid feed is pumped upwards when passing through the plurality of membrane modules, and at least one layer of membrane modules, optionally 2, 3, 4 or more or all layers, each comprises a second inlet (24) for a secondary fluid comprising washing fluid or diafiltration buffer wherein the secondary fluid is added to the feed or retentate flow, and optionally comprises a common secondary fluid feeding pipe (27a, 27b, 27c, 27d) for all membrane modules at one level.

9. Method for filtrating a liquid in an apparatus for cross-flow membrane filtration comprising:
a) An amount of fluid feed is continuously pumped with a baseline pressure through a loop comprising a multiplicity of n membrane modules that are serially connected, the fluid feed and permeate flow concurrently through each of the n membrane modules,
b) generated permeate is continuously drained from each membrane module through a permeate outlet,
c) the permeate pressure at the permeate outlet of each membrane module is controlled keeping trans membrane pressure within a selected range, wherein the pressure is also measured at the feed inlet end, the outlet end, or both the inlet end and the outlet end of the membrane module,
d) wherein, to obtain a selected separation, the number n of membrane modules that the fluid feed flows through is varied either when designing the separation process or during the separation process so that a number of active membrane modules may be varied before or during operation.

10. The method according to claim 9, wherein a secondary fluid comprising a diafiltration buffer is added to at least one of the n membrane modules, or the secondary fluid is added to a plurality of membrane modules, or the secondary fluid is added to a plurality of segments of membrane modules at one or 2 or 3 or 4 or more levels or at all levels.

11. The method according to claim 9, wherein the pressure p1 at the outlet of a first membrane module (1a) is higher than the pressure p2 at the outlet of a second membrane module (1b), and similarly for the following membrane modules so that p1>p2>p3> . . . >pn.

12. The method according to claim 9, wherein the pressure at the feed inlet end of the first membrane module is in the range of 0.05-35 bar, or the trans membrane pressure for each membrane module is in the range of 0.02-12 bar.

13. The method according to claim 9, wherein a pressure with which fluid feed is pumped into the loop, is above 0.2 bar, or above 0.3 bar, or above 0.5 bar, or above 0.9 bar, or above 1.0 bar.

14. The method according to claim 10, wherein an applied booster pressure (PB) is above 0.1 bar per module in the loop or segment, so that PB>n·0.1 bar, or PB is above 0.2 bar, or above 0.3 bar, or above 0.4 bar, or above 0.5 bar, or above 0.6 bar, or above 0.9 bar, or above 1.0 bar per module in the loop or segment.

15. The method according to claim 9, wherein the fluid feed is a fluid in dairy industry or in dairy ingredients industry or in liquid food industry requiring accurate simultaneous control of the trans membrane pressure and cross flow, in particular the feed fluid is a feed fluid for protein separation, fat separation, protein fractionation, alcohol separation or micro-organism separation in dairy industry or dairy ingredients industry, liquid food industry, liquid beverage industry or liquid life science industry, wherein the fluid feed is
dairy industry and dairy ingredients industry cheese whey or
dairy industry and dairy ingredients industry whey protein concentrate or
dairy industry and dairy ingredients industry skim milk or
dairy industry and dairy ingredients industry milk protein concentrate or
dairy industry and dairy ingredients industry raw whole milk or
dairy industry and dairy ingredients industry whole milk or
dairy industry and dairy ingredients industry microfiltration permeates or
liquid food industry vegetable protein solutions or
liquid food industry fish protein solutions or
liquid food industry meat protein solutions or
liquid food industry microfiltration permeates or
beverage solutions.
